(19) United States
(12) Patent Application Publication
(10) Pub. No.: US 2024/0320387 A1
(43) Pub. Date: Sep. 26, 2024

(54) PARALLELIZED, SCALABLE SIMULATION DISPATCH

(71) Applicant: X Development LLC, Mountain View, CA (US)

(72) Inventors: Amanda McNary, Redwood City, CA (US); Raymond Daly, Palo Alto, CA (US); Sergei Babinskii, Mountain View, CA (US); Sushant Kumar, San Jose, CA (US)

(21) Appl. No.: 18/188,293

(22) Filed: Mar. 22, 2023

(51) Int. Cl. G06F 30/20

(52) U.S. Cl. CPC G06F 30/20; G06F 2113/04

(57) ABSTRACT

Methods, systems, and apparatus, including computer programs encoded on computer storage media, for electric grid modeling and simulation. One of the methods includes, obtaining a model of an electrical power system; executing a simulation of the model including by separately simulating, in parallel, behaviors of the electric power system during each of a consecutive series of time periods to provide individual simulation results for each time period, where the consecutive series of time periods together represent a simulation time frame over which the behaviors of the electric power system are simulated; combining the individual simulation results into a simulation output for the simulation time frame; and providing, for display, the simulation output.

### TECHNICAL FIELD

The present specification relates to electrical power grids, and specifically to simulating models of electrical power grids.

### BACKGROUND

Power grids contain thousands of miles of wires, millions of poles, and other expensive assets, e.g., transformers, capacitors, and switches. Modeling and simulation of such systems is computationally expensive and time consuming. Electric grid simulations occupy computer resources for extended periods of time. It is therefore desirable to develop improved simulation process to reduce execution time and make more efficient use of computing resources.

### SUMMARY

In general, the present disclosure relates to executing large scale simulations of an electric power grid. The simulation is divided into instances that that are distributed to multiple processing cores for parallelized simulation. The full time frame of the simulation is broken into multiple shorter time periods. Each time period is simulated in parallel, e.g., on different processing cores or computer systems. The length of the time periods T for the parallelized simulations can be changed based on the requirements of the simulation, the total time that the simulation runs, or both. For example, the infrastructure can run simulations in parallel (each for a different time period T), making assumptions about a starting state for each simulation. The results can then be combined into a single result representing the full time frame of the simulation.

The input for a simulation can include, but is not limited to, a base model of the electric grid, baseline operating conditions, estimated operating conditions at the end of an immediately preceding time period (e.g., estimated conditions at the end of Tₙ₋₁ for simulation of period Tₙ), and mutation parameters. For example, a base model of the electric grid can is a computer model of the electric grid, or portion thereof. Baseline operating conditions can include baseline load curves of the components on the grid and can represent expected electrical load over a time period. Example estimated operating conditions can include estimates of voltage, current, phase, and/or power values at different locations on the electric grid at the end of each time period. The estimated operating conditions can be used as initial conditions for parallel simulations of time periods subsequent to the first time period.

Mutation parameters can represent alterations to the base model and/or baseline operating conditions for each time period T₂-T_{N}, after the first time period. For example, mutations can include, but are not limited to, changes to the baseline load curve, changes to the base model, the addition of simulation events, or a combination thereof. Example changes to the load curve can include, but are not limited to, adjustments to account for seasonal changes in electricity demand, adjustments to account for the addition of loads to the electric grid, adjustments to account for the removal of loads, or a combination thereof. Example changes to the base model can include, but are not limited to, addition of power sources, expansion of the electrical grid, addition of renewable power sources at existing loads (e.g., addition of consumer/commercial solar power), or a combination thereof. The addition of simulation events to the baseline operating conditions can include the addition of events including, but not limited to, singular component failure, multi-component failure, component upgrades, component removal, overloads, transient overloads, or a combination thereof. For example, the simulation can be run to explore the response of the network to mutations such as load changes (increased housing production or industrial expansion). These mutations can also be based on changes to electric production, such as an increase in production through new solar panel sites or a decrease in production with the removal of a coal burning plant.

As an individual time period simulation is completed, a verification process can be used to validate whether the starting state assumptions (e.g., the mutations to the baseline operating conditions including estimated operating conditions at the end of an immediately preceding time period Tₙ₋₁) for that time period were within an acceptable tolerance level. For example, if the end state for the simulation for period Tₙ₋₁ is outside of a tolerance level as compared to the starting state assumptions for the simulation of period Tₙ, the simulation for time period Tₙ can be rerun with adjustments to its starting state assumptions based on the end state of the simulation for period Tₙ₋₁. In some implementations, all re-simulations can be executed, if necessary, after the initial batch of simulations have been run in parallel.

The simulation process described herein can be employed to run a particular analysis of a grid component, a new grid interconnection, or for overall grid trend predictions. The outputs of the simulation can be broken down into any time period desired in order to observe the particular components or parameters at a desired point of time in the simulation (e.g., 12:30 AM on Jan. 10, 2025). The results of several paralleled simulations can be aggregated together into one result giving a synthesized and user friendly output. The results of a simulations can then be fed back into the simulation in order to extrapolate on the trends or abnormalities observed. In order to tailor the results of the data, certain boundary conditions can be set on the simulation for example time or geography.

Simulation of different electric grid scenarios can be run iteratively or recursively based on the desired results. For example, when looking for convergence in data, the simulations can be run until a number of the simulations within a scenario are acquiring data within a threshold amount of a convergence point. This convergence point can then be further evaluated for pertinent information. For example, when observing certain abnormalities within an electric grid, there may be several paths that could lead to the same result. After the simulations have run and have approached a convergence, the results can be observed in order to reveal the cause of the abnormality. The results of this simulation can then be used to refine the simulation and continue to broaden the results. If a run of the simulation shows little variance from the baseline despite the mutation, then the results can be fed into the baseline of the next simulation and run again. The evaluation of the data can encompass more than a single point in time. For example, the results could display over a two day time period from midnight to 0600. As the simulations are refined, the load characteristics can be defined as granularly as desired. For example, the loads can be changed to observe the results of changing lightbulbs or the model of a transformer in a system.

In general, one innovative aspect of the subject matter described in this specification can be embodied in methods that include the actions of obtaining a model of an electrical power system; executing a simulation of the model including by separately simulating, in parallel, behaviors of the electric power system during each of a consecutive series of time periods to provide individual simulation results for each time period, where the consecutive series of time periods together represent a simulation time frame over which the behaviors of the electric power system are simulated; combining the individual simulation results into a simulation output for the simulation time frame; and providing, for display, the simulation output.

In some implementations the process includes, receiving user input defining simulation parameters that include one or more of: a length of the simulation time frame, a length of the time periods, a number of the time periods, a load curve data representing a baseline load curve of the electrical power system over a canonical time-period, and mutation data representing one or more alterations to the model and the baseline load curve to be applied during different time periods of the simulation.

In some implementations, executing the simulation includes assigning a respective time-period to each of a plurality of processors, where each processor is configured to separately execute simulation of behaviors of the electric power system during the respective time-period.

In some implementations, executing the simulation includes providing, to each processor, the model of the electric power system, load curve data representing a baseline load curve of the electrical power system, and mutation data representing one or more alterations, relevant to the respective time period, to at least one of the model or the load curve data.

In some implementations, executing the simulation includes: generating, for one or more time periods, a time-period specific load curve data representing a baseline load curve of the electrical power system that is adjusted to incorporate mutation data indicating one or more changes to the load curve relevant for the respective time period; and providing, to each processor, time-period specific load curve data associated with the respective time-period assigned to the processor.

In some implementations, executing the simulation includes: generating, for one or more time periods, a time-period specific model representing the model of the electrical power system that is adjusted to incorporate mutation data indicating one or more changes to the electric power system relevant for the respective time-period; and providing, to each processor, the time-period specific model of the electric power system associated with the respective time-period assigned to the processor.

In some implementations, executing the simulation includes: applying, for each time-period subsequent to a first time period, estimated initial conditions of the electric power system at a start time of the respective time period; and verifying, for at least one particular time-period subsequent to a first time period, accuracy of the estimated initial conditions for the particular time period including by determining whether the estimated initial conditions for the particular time period are within a threshold value of simulation output values from simulation of an immediately preceding time period.

In some implementations, executing the simulation includes: responsive to determining that the estimated initial conditions for the particular time period are not within the threshold value of the simulation output values from simulation of the immediately preceding time period: adjusting the estimated initial conditions for the particular time-period based on the simulation output values to obtain adjusted initial conditions; and re-simulating behaviors of the electric power system for at least a portion of the particular time-period by applying the adjusted initial conditions.

In some implementations, verifying accuracy of the estimated initial conditions includes: responsive to determining that the estimated initial conditions for the particular time period are not within the threshold value of the simulation output values from simulation of the time period immediately preceding the particular time period, determining that simulation output values associated with the particular time period converge with simulation output values associated with the immediately preceding time period during a period of overlap between the particular time period and the immediately preceding time period; and where re-simulating behaviors of the electric power system for at least a portion of the particular time-period by applying the adjusted initial conditions includes re-simulating only a period of time during which the simulation output values associated with the particular time period did not converge with the simulation output values associated with the immediately preceding time period.

In some implementations, each time-period, except for a last one of the time periods, overlaps with a portion of an immediately subsequent time-period.

In some implementations, the mutation data includes one or more of: an addition of a solar power source to the model at a respective time-period, a change to an electric system component at a respective time-period, and an expansion of the electric power system at a respective time-period.

The subject matter described in this specification can be implemented in various implementations and may result in one or more of the following advantages. Implementations may reduce the execution time of power grid simulations. For example, the parallel simulation techniques described herein can reduce simulation execution times by a factor of the number of time periods simulated in parallel. Such an improvement permits more evaluations of electric grid operations in a shorter amount of time and may result quicker detection of potential grid problems, such as blackout or brown out conditions.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram of an example environment for executing complex simulations using parallel processing.

FIG. 1B is a diagram that depicts an example of how simulation input data is distributed among processing cores.

FIG. 1C is diagram that depicts an example initial condition verification process for individual simulation time periods.

FIG. 2 is a diagram of an example of a user interface depicting output of a power grid simulation.

FIG. 3 is a flow chart of an example electric grid simulation process.

FIG. 4 is a schematic diagram of a computer system.

Like reference numbers and designations in the various drawings indicate like elements.

### DETAILED DESCRIPTION

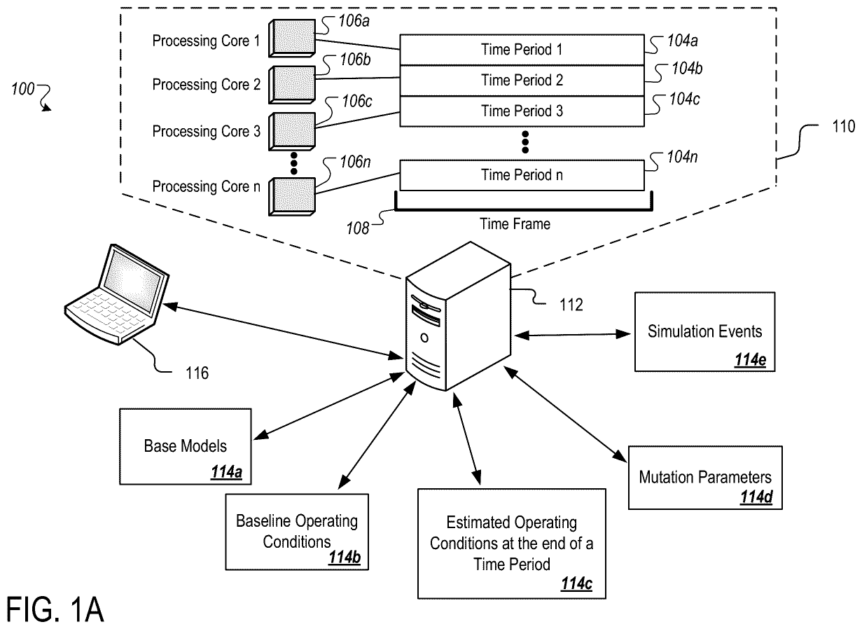

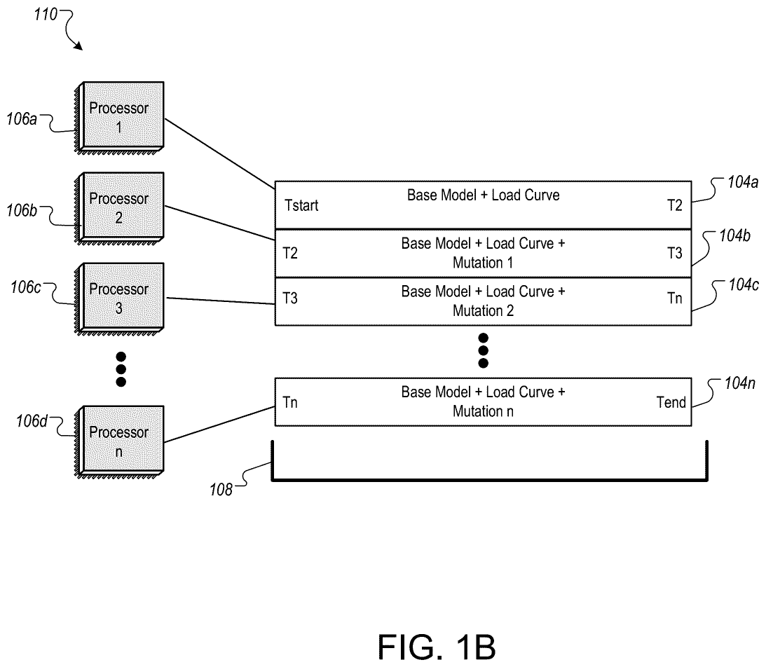

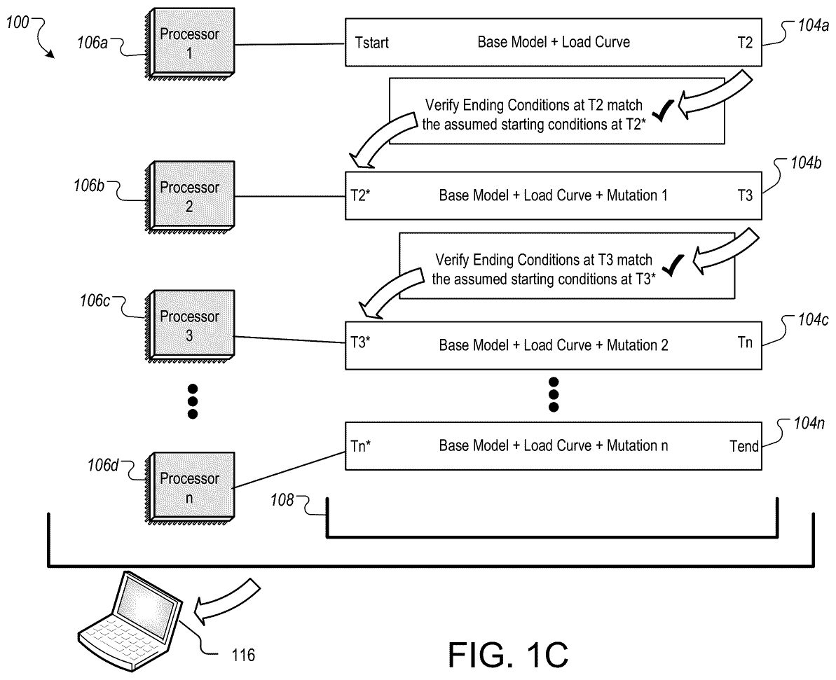

FIG. 1A is an example of an environment 100 for executing complex simulations by scaling the simulation for execution using parallel processing. The environment 100 includes a modeling system 110 in communication with at least one user computing device 116. The modeling system 110 can run on a server 112, (e.g., a series of networked computers, multiple processing cores, a network of servers). For example, the modeling system 110 includes one or more servers 112 or other centralized computing system in communication with multiple processing cores 106. The processing cores 106 can include, e.g., individual processors, computers, or servers. The processing cores are configured to each run a portion of the simulation. For example, twelve processors can run a simulation with a one year time frame, each processor can run an independent simulation for a one month time period. The system 110 can receive as input, several variables including, but not limited to base models 114a, baseline operating conditions 114b, and mutation parameters 114d. The output can be displayed on an output device 116. In some examples, server 112 controls the overall simulation and assigns specific time periods to each core 106 to for individual execution.

The modeling system 110 uses one or more inputs 114 to generate and run a model simulation of an electric grid and output results. The inputs 114a-e (referred to collectively as inputs 114) to the system 110 can include but are not limited to, a base model 114a, baseline operating conditions 114b, estimated end of period operations conditions 114c, mutation parameters 114d, and simulation events 114e. The outputs can include, but are not limited to voltage, current, power, phase, etc. at various locations within the electric grid model. The system 110 can operate efficiently by performing parts of the simulation time frame 108 across multiple processing cores 106a-106n (referred to collectively as processing cores 106) in parallel during individual time periods 104. For example, a yearlong time frame 108 simulation could be run in 12 monthly time periods 104, each simulated in parallel on a separate processing core, thus taking 1/12 the time to perform. The results of the simulation can then be outputted to a user via an output device 116.

The base model 114a is a computer software representation of an actual electric grid. The server 112 can receive user input selected an existing base model 114a from a database of models, and, in response, load the selected model from storage. In some examples, the server 112 can permit a user to provide a model for simulation, e.g., a user can be permitted to upload a new base model 114a. The base model 114a is a particular model of an electric grid the forms the starting point for any given simulation. For example, a base model 114a may be a representation of a particular electric grid (e.g., a portion of the Los Angeles electric grid) at the start of a simulation time frame (e.g., Jan. 1, 2022). The base model 114a may be altered during a simulation by a set of mutation parameters 114d. For example, additional solar power resources may be added to the base model 114a at a particular location on May 15, 2022.

The baseline operating conditions 114b can include baseline load curves of the components on the grid and can represent expected electrical load over a time period. For example, the baseline operating conditions 114b can include a set of baseline load curves indicating the expected variation of electric loads (e.g., in kW or MW) at different locations on the base electric grid model 114a over a period of time (e.g., during an expected simulation time period). In some examples, the baseline operating conditions 114b include a set of “canonical” load curves for a particular base model 114a. Such a set of load curves can represent the expected normal variation of loads over the course of a defined time period (e.g., a day or week). Such “canonical” load curves may represent an average of actual load data for a particular electric grid as it operates in the present time and would form a basis for simulating various load changes that may be expected in the future (e.g., addition of new loads or testing extreme events). The set of curves may include “canonical” load curves representing expected electrical demand for certain normal grid operating conditions, e.g., weekday load curves, weekend load curves, holiday load curves, each with slight variation for different seasons.

Mutation parameters 114d represent alterations to the base model and/or baseline operating conditions for each time period. For example, mutations can include, but are not limited to, changes to the baseline load curve, changes to the base model, the addition of simulation events, or a combination thereof. Example changes to the load curve can include, but are not limited to, adjustments to account for seasonal changes in electricity demand, adjustments to account for the addition of loads to the electric grid, adjustments to account for the removal of loads, or a combination thereof. Example changes to the base model can include, but are not limited to, addition of power sources, expansion of the electrical grid, addition of renewable power sources at existing loads (e.g., addition of consumer/commercial solar power), or a combination thereof.

In some examples, mutation parameters 114d can also include the addition of simulation events 114e. A simulation event is an event (typically a transient event) that a user may include in at a particular time in a simulation to evaluate the electric grid's response to the event. A simulation event can include a weather events, lightning strikes, an abrupt loss of power one or more power sources, an abrupt change to the grid model (e.g., loss of a feeder or substation), etc.

Simulation inputs can, optionally, include estimated operating conditions 114c for each or some of the simulation time periods. The estimated operating conditions can be used as initial conditions for parallel simulations of time periods, subsequent to the first time period. Example estimated starting conditions can include estimates of voltage, current, phase, and/or power values at different locations on the electric grid. In some examples, estimated operating conditions 114c can include estimates of voltage, current, phase, and/or power values at different locations on the electric grid at the end each time period.

A user can define the time frame 108, as a simulation input parameter, which can represent the entire time that the simulation can cover. The time frame 108 can start from the time Tₛₜₐᵣₜ and continue until T_{end}. For example, a time frame 108 represents the entire time that the user desires to simulate. The server 112 divides the simulation into multiple time periods 104a-104n and assigns execution of the simulation for each time period to an individual processing core 106a-106n. The time periods 104a-d are contained within the time frame 108 and can occur between Tₛₜₐᵣₜ and T_{end}. For example, in a year-long time frame 108, that increments the time periods 104 in days, the Tₛₜₐᵣₜ value can be day 1 and the T_{end} value can be day 365. In other words, processing core 106a would execute a simulation of the electric grid model 114a on day 1, processing core 106b would execute a simulation of the electric grid model 114a on day 2, and so on. In this example, the more parallel simulation time periods 104, the faster the simulation may run.

FIG. 1B is a diagram that depicts an example of how simulation input data is distributed among processing cores 106. Once the server 112 has received user input 114 to define a particular simulation, the server executes the simulation by distributing portions of the simulation to be executed in parallel by individual processing cores 106. The simulation of over the course of an entire time frame 108 (e.g., 1 year) is divided into individual time periods 104a-104n. Each processing core 106a-106n is assigned a time period during which the processing core 106 will simulate the behaviors of the electric grid. For example, processing core 106a is assigned the first time period from Tₛₜₐᵣₜ to T₂ (e.g., day 1), processing core 106b is assigned the first time period from T₂ to T₃ (e.g., day 2), processing core 106c is assigned the first time period from T₃ to T₄ (e.g., day 3), and so on. The behavior of the electric grid is thus simulated over the entire simulation time frame 108 (e.g., 1 year) with each processing core 106 executing the simulation of one day of grid operations.

In order for the processing cores 106 to execute their particular portion of the overall simulation, the server 112 passes appropriate simulation parameters to each that are relevant to its portion of the simulation. For example, the server 112 may provide each processing core 106 with the base model 114a of the electric power grid, baseline operating conditions 114b, estimated operating conditions 114c, and mutation parameters 114d relevant the respective simulation time period 104 assigned to each processing core 106. For example, processing core 106c is assigned to execute the simulation of the grid model for time period 104c. Time period 104c may be weekday in the winter (e.g., Feb. 3, 2022). The server 112 may provide processing core 106c with the base model 114a, “canonical” weekday winter load curves, mutation data for the addition of a new load during the time period to alter the model and/or the load curves, mutation data for simulating the loss of a feeder at 5:30 pm, and estimated operating conditions of the grid at the end of time period 104b (e.g., at time T₃) to serve as initial conditions for simulating time period 104c.

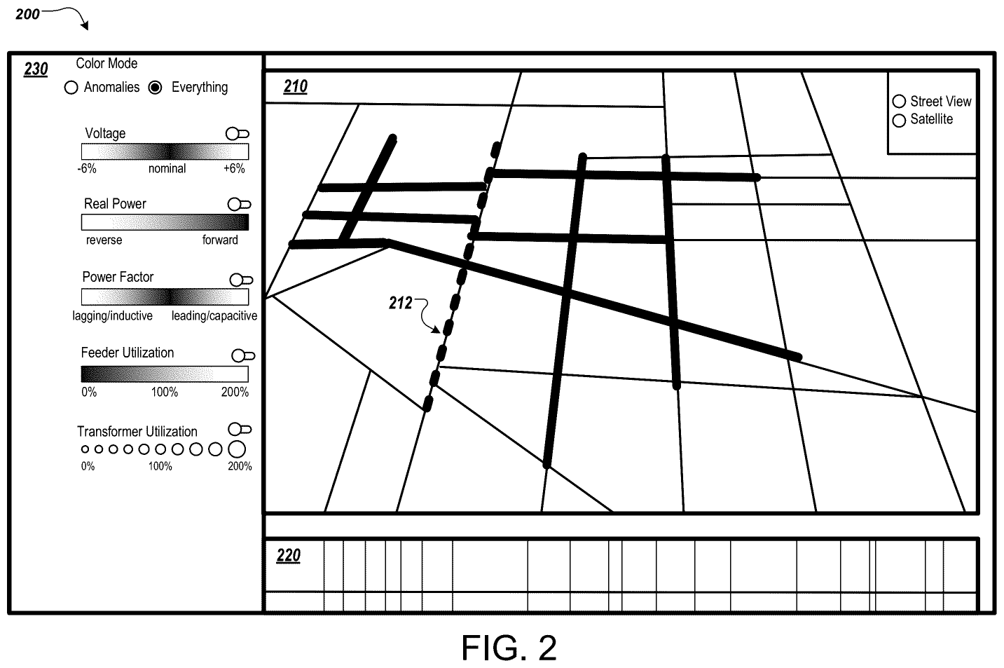

Once each processing core 106 completes the simulation of its assigned time period 104, the processing core 106 sends its simulation output (e.g., electric grid voltages, currents, power factors, power values, phase angles, etc.) back to the server 112. The server 112 combines the outputs from each processing core 106 into the simulation output over the entire time frame 108 of the simulation. For example, the server 112 can arrange the results in order by time period and concatenate the results into a simulation output for presentation to a user (e.g., as shown and described in reference to FIG. 2).

In some implementations, each processing core 106a-d can simulate one or more time periods 104a-d in parallel. Each processing core 106a-d can be physically independent cores. The processing cores 106a-d can be hyper-threaded processors, servers, or otherwise. For instance, a processing core 106 can run a simulation time period 104 in increments of days, which would require thirty processing cores, running thirty parallel simulations, until thirty days of simulation are complete.

FIG. 1C is diagram that depicts an example initial condition verification process for individual simulation time periods. In some implementations, the system 110 can verify that the initial conditions used for each time period 104 were accurate. For example, as results are received from each processing core 106, server 112 can compare the results at the end of each time period to the estimated operating conditions for that time periods—which served as initial conditions for a subsequent time period. For instance, the simulation results of processing core 106b at time T₃ (the end of time period 104b) can be compared to the estimated grid operating conditions at time T_{3*} which were used as initial conditions for simulating time period 104c.

If the computed simulation results at T₃ deviate from the estimated operating conditions at T₃* by more than a threshold amount, the system 110 can rerun the simulation of 104b with revised initial conditions. For instance, if the estimated initial conditions for time period 104c at time T_{3*} were found to differ from the simulation results for time period 104b at time T₃ by greater than the permitted threshold value, then time period 104c can be re-simulated using the actual results at time T₃ from time period 104a as the initial conditions. In some implementations, the adjusted initial conditions can be an average or interpolated value between the original estimated initial conditions for the time period and the computer simulation results of the immediately preceding time period.

FIG. 2 is a diagram of an example of a user interface 200 depicting output of a power grid simulation. The interface 200 illustrates several example outputs related to the simulation which can include, e.g., real power, reactive power, power factor, current flow, asset utilization, phase imbalance, and other electric grid characteristics. The example output to the user can include a line-diagram includes one or more line segments 212 (illustrated as dashes in one branch of the line diagram). Each line segment can represent a portion of the wires of the power grid model and the results of the simulation. Attributes of each line segment 212 can represent power grid data at a particular spatial location of the power grid. In some implementations, the spatial resolution (and size in pixels) of each line segment can vary to accommodate the spatial resolution of the received power grid data. For example, if power grid data is available at 1000 ft intervals along a 10,000 ft length of feeder line, the GUI can represent that particular length of feeder line with 10 different line segments. The color, shade, width, height, or any combination of these or other attributes of a line segment can indicate one or more characteristics of the power grid at the line segment at a particular point in time. Line segments can also show moving arrows indicating the direction and magnitude of a characteristic of the power grid at the line segment at a particular point in time.

The window 210 can represent a layout of the electric grid model. Through this window a user can navigate the grid at large and select portions of the grid to observe or individual components to monitor. For instance, a user can select a transmission line and observe the parameter changes over individual time periods or over the whole time frame of a simulation. Window 220 illustrates a timeline that can be used to navigate through simulation results for each of the different time periods simulated during the full time frame of the simulation.

Window 210 can include representations that indicate the line segments 212 of an electric grid, such as power lines. These individual components can be selected by the user for observation. An entire area of line segments 212 can be selected in order to determine the performance of sections of the grid. For example, a user can select a neighborhood and observe as the number of houses in the neighborhood expands, the effects on the grid components servicing that area.

A user can change what is displayed in window 210 using the menu 230. The selections can vary based on the parameters of the simulation and vary based on the desired output of the user. For instance, a user can decide to run a simulation to observe the overall load on certain portions of the grid that will be upgraded to include electric car chargers. As the simulation progresses and more car chargers are installed, the user can observe the results and be more informed of upgrades necessary to the system in order to support the new components.

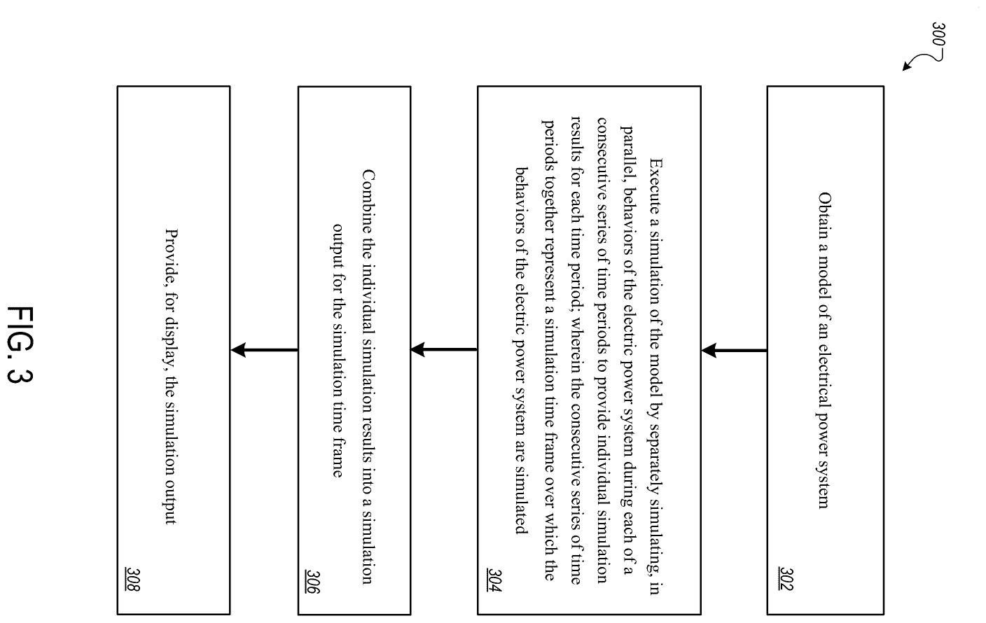

Further options can be included in the menu 230. The menu 230 includes a menu. The menu includes user-selectable icons that permit toggling representation of different characteristics of the power grid on and off. The user can select the icons of the menu in the menu 230 in order to view one characteristic or a selected combination of characteristics in the window 210 and window 220. FIG. 3 is an example electric grid simulation process 300. Process 300 can be executed by one or more computing systems including, but not limited to, modeling system 110 and server 112, described above, to simulate behaviors of an electric power grid based on an electrical grid model 114a.

The system obtains a model of an electrical system (302). For example, the system obtains a model of an electrical power grid. The model can include mathematical and geographic representations of electrical components within the electrical system and electrical connections between components. The system can receive user input selected an existing model from a database of models, and, in response, the system loads the selected model from storage. In some examples, the system can permit a user to provide a model for simulation, e.g., a user can be permitted to upload a new model.

In addition to the selection of a computer model, in some examples, the system can receive user input indicating simulation parameters that define criteria for performing a particular simulation. Simulation parameters can include the selection of a base model for simulation, baseline operating conditions for the simulation, estimated operating conditions, and mutation parameters. Baseline operating conditions can include baseline load curves of the components on the grid and can represent expected electrical load over a time period. Example estimated operating conditions can include estimates of voltage, current, phase, and/or power values at different locations on the electric grid at the end each time period. The estimated operating conditions can be used as initial conditions for parallel simulations of time periods subsequent to the first time period. Mutation parameters can represent alterations to the base model and/or baseline operating conditions for each time period T₂-T_{N}, after the first time period. For example, mutations can include, but are not limited to, changes to the baseline load curve, changes to the base model, the addition of simulation events, or a combination thereof. Example changes to the load curve can include, but are not limited to, adjustments to account for seasonal changes in electricity demand, adjustments to account for the addition of loads to the electric grid, adjustments to account for the removal of loads, or a combination thereof. Example changes to the base model can include, but are not limited to, addition of power sources, expansion of the electrical grid, addition of renewable power sources at existing loads (e.g., addition of consumer/commercial solar power), or a combination thereof.

Simulation parameters can, optionally, include estimated starting conditions for each or some of the simulation time periods. The estimated operating conditions can be used as initial conditions for parallel simulations of time periods subsequent to the first time period. Example estimated starting conditions can include estimates of voltage, current, phase, and/or power values at different locations on the electric grid.

The system executes a simulation of the model on a plurality of individual processors (304). The system executes the simulation by separately simulating, in parallel, behaviors of the electric power system during each of a consecutive series of time periods. The system divides the time frame over which the full simulation is to be performed into separate time periods. Each time period can be assigned to a different processor (e.g., processing cores 106) for simulation, wherein each time periods together represent the full time frame over which the behaviors of the electric model are simulated. Once assigned, each processor executes a separate simulation of the model over its assigned time frame.

For example, server 112 can control the overall simulation and assign different time periods to individual processing cores 106 for simulation. The server 112 can divide the full time frame of the simulation requested by a user into a number of unique time periods. For example, as discussed above, a yearlong simulation can be divided into 365 different daily time periods. Each processing core 106 can be designated to simulate behaviors of the electrical system model during a different day. In some implementations, the server 112 can determine how many time periods to divide the simulation time frame into based on the number of processing cores 106 available.

The system can provide each processor with the data to simulate its assigned time period. For example, the server 112 can provide each processing core 106 with the computer model of the electric power system, baseline operating conditions, estimated operating conditions, and mutation data relevant the respective time period each processing core 106 is assigned to execute. The server 112 can provide each processing core 106 with access to a base computer model of the electric grid (e.g., the model without any changes indicated in the mutation data) or a copy of the model and mutation data related to changes to the model for the time period assigned to the respective core 106. The server 112 can provide each processing core 106 with baseline load curve for the model and mutation data related to changes in the loads for the time period assigned to the respective core 106. Each core 106 can then adjust the baseline load curve based on the changes indicated by the mutation data for the specific time period. If applicable, the server 112 can provide each processing core 106 with additional mutation data relevant to the assigned time period such as any simulation events to be inserted during execution of the restive time period.

In some implementations, the server 112 also provides each processing core 106 with estimated operating conditions of the electric grid at the beginning of the assigned time period (e.g., estimated initial conditions). For example, the estimated operating conditions may be provided by a user or, in some implementations, determined by server 112. For example, the server 112 can use default values as the estimated operating conditions for each time period. For example, the default values can be starting assumptions for voltage, current, and power at various locations within the electric grid model that are based on historical data. The server 112 can store standard starting assumptions that represent normal operating conditions for the various locations of the electric grid based on actual grid data or previously performed simulations.

In some implementation, the server 112 can adapt the standard starting assumptions based on mutation data associated with a particular simulation being performed to develop more accurate initial condition estimates for a particular one or more of the time periods. For example, the server 112 can make seasonal adjustments for time periods that occur during different seasons. For example, the server 112 can make adjustments to the standard starting assumptions that increase estimated current or power values to account for increased power usage during the summer/winter months accounting for more air-conditioning or heating loads being active.

In some implementations, the server 112 generates time-period specific load curve data for each processing core 106. For example, the server 112 can apply relevant changes, if any, indicated by the mutation data to the baseline load curve data for each time period. For example, if the mutation data indicates an increase in EV charging load is to be added during a particular time during the simulation, the server 112 can identify which time periods would be affected and increase the load indicated by the load curve for those time periods as indicated in the mutation data. The server 112 can then provide each time-period specific load curve to the appropriate processing core 106.

In some examples, the server 112 can apply any relevant mutations to the computer model before sending the model to each processing core 106. For example, the server 112 if the mutation data includes the addition of a new feeder to the grid model at a particular time during the simulation, the server 112 can identify which time periods would be effected and add the new feeder to the time-period specific version of the grid model that will be provided to processing cores 106 assigned to simulate the effected time periods.

The system combines the individual simulation results into a simulation output for the simulation time frame (306). For example, server 112 receives the simulation results from each processing core 106 and combines the results into a comprehensive simulation output indicating the behavior of the electric grid model over the course of the full simulation time frame 108. The server 112 can combine the individual time periods 104, that correspond to the time frame 108, to present an overall time frame 108 over which the simulation is run. In some examples, the server 112 can output the full simulation results as a single data set representing the overall simulation time frame 108. The server 112 can concatenate the temporal results computed by each processing core 106 into a chronological representation of grid behavior over the full simulation time frame 108 and provide the results to a graphical user interface for presentation to a user (308).

In some examples, simulation output from each processing core 106 can include time series data representing electrical properties for each node (e.g., electrical component or electrical node) in a given grid model. The server 112 can concatenate the temporal results computed by each processing core 106 into a chronological representation of grid behavior over the full simulation time frame 108 for each node. In some examples, the server 112 can compare the time series data to certain threshold values that would result in one or more component or grid electrical violations (e.g., over current, under voltage, etc.). Any detected violations can be aggregated and reported on the graphical user interface.

In some implementations, the system can verify that that the estimated initial conditions for each time period were accurate. For example, either server 112 or each processing core 106 can verify that the accuracy of the estimated initial conditions for each time period (subsequent to the first time period) by comparing the calculated simulation results of the immediately preceding time period to the estimated initial conditions. For example, referring to FIG. 1C, the estimated initial conditions for time period 104b at time T_{2*} can be verified by comparison with the simulation results at the competition of time period 104a (time T₂). If the initial conditions at time T_{2*} match the simulation results at time T₂ within a threshold amount of error, the accuracy of the estimated initial conditions is verified. The comparison can be performed by the processing core 106b assigned to simulation time period 104a or by the server 112.

If the estimated initial conditions for any particular time period are not within a threshold error tolerance, the estimated initial conditions for that time period can be adjusted and the time period re-simulated using the adjusted initial conditions. In some implementations, the simulation results of the immediately preceding time period can be applied as the initial conditions for re-simulating the time period whose estimated initial conditions were found to be inaccurate. For instance, if the estimated initial conditions for time period 104b at time T_{2*} were found to differ from the simulation results for time period 104b at time T₂ by greater than the permitted threshold value, then time period 104b can be re-simulated using the actual results at time T₂ from time period 104a as the adjusted or new initial conditions. In some implementations, the adjusted initial conditions can be an average or interpolated value between the original estimated initial conditions for the time period and the computer simulation results of the immediately preceding time period.

In some implementations, the time periods can be defined to overlap slightly. For example, daily time periods can be defined to overlap by a few hours. Time period 104a may extend two to three hours into time period 104b, and so on. In such implementations, the system can check to determine whether the simulation results of a preceding time period converge with simulation results for a subsequent time period during the period of overlap between the two time periods. If the values between the two time periods converge sufficiently, the system can determine that it is not necessary to re-simulate the subsequent time period. If, however, the simulated results do not converge during the overlap period, the system can re-simulate the subsequent time period using adjusted initial conditions. In some implementations, even if the simulation results of the two time periods do eventually converge during the overlap period, at least the portion of the subsequent time period that did not converge with the results of the immediately preceding time period can be re-simulated using adjusted initial conditions.

In some implementations, the process 300 can include additional steps, fewer steps, or some of the steps can be divided into multiple steps. For example, the process can include additional inputs to the model of an electric grid system, such as a load curve, mutation, or more. In other examples, the process 300 can rerun certain portions of the simulation based on user input, required metrics, comparative metrics, or more.

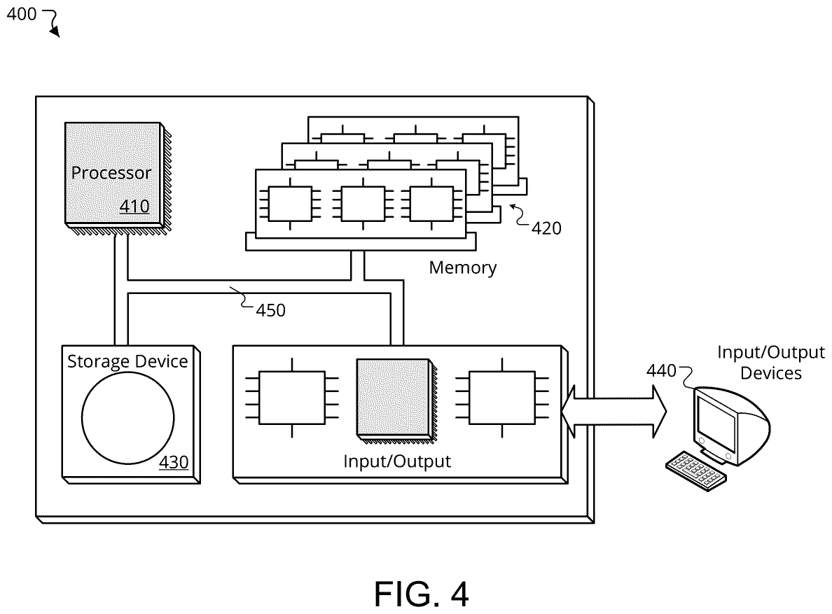

FIG. 4 is a schematic diagram of a computer system 400. The system 400 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 400) and their structural equivalents, or in combinations of one or more of them. The system 400 is intended to include various forms of digital computers, such as laptops, desktops, workstations, personal digital assistants, servers, blade servers, mainframes, and other appropriate computers, including vehicles installed on base units or pod units of modular vehicles. The system 400 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

A number of implementations have been described. Nevertheless, it will be understood that various modifications may be made without departing from the spirit and scope of the disclosure. For example, various forms of the flows shown above may be used, with steps re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., a Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

Particular implementations of the invention have been described. Other implementations are within the scope of the following claims. For example, the steps recited in the claims, described in the specification, or depicted in the figures can be performed in a different order and still achieve desirable results. In some cases, multitasking and parallel processing may be advantageous.

What is claimed is:

1. An electrical power grid simulation method comprising:
obtaining a model of an electrical power system;
executing a simulation of the model including by separately simulating, in parallel, behaviors of the electric power system during each of a consecutive series of time periods to provide individual simulation results for each time period, where the consecutive series of time periods together represent a simulation time frame over which the behaviors of the electric power system are simulated;
combining the individual simulation results into a simulation output for the simulation time frame; and
providing, for display, the simulation output.

2. The method of claim 1, comprising:
receiving user input defining simulation parameters that comprise one or more of:
a length of the simulation time frame,
a length of the time periods,
a number of the time periods,
a load curve data representing a baseline load curve of the electrical power system over a canonical time-period, and
mutation data representing one or more alterations to the model and the baseline load curve to be applied during different time periods of the simulation.

3. The method of claim 1, where executing the simulation comprises:
assigning a respective time-period to each of a plurality of processors, where each processor is configured to separately execute simulation of behaviors of the electric power system during the respective time-period.

4. The method of claim 3, where executing the simulation comprises:
providing, to each processor, the model of the electric power system, load curve data representing a baseline load curve of the electrical power system, and mutation data representing one or more alterations, relevant to the respective time period, to at least one of the model or the load curve data.

5. The method of claim 3, where executing the simulation comprises:
generating, for one or more time periods, a time-period specific load curve data representing a baseline load curve of the electrical power system that is adjusted to incorporate mutation data indicating one or more changes to the load curve relevant for the respective time period; and
providing, to each processor, time-period specific load curve data associated with the respective time-period assigned to the processor.

6. The method of claim 3, where executing the simulation comprises:
generating, for one or more time periods, a time-period specific model representing the model of the electrical power system that is adjusted to incorporate mutation data indicating one or more changes to the electric power system relevant for the respective time-period; and
providing, to each processor, the time-period specific model of the electric power system associated with the respective time-period assigned to the processor.

7. The method of claim 3, where executing the simulation comprises:
applying, for each time-period subsequent to a first time period, estimated initial conditions of the electric power system at a start time of the respective time period; and
verifying, for at least one particular time-period subsequent to a first time period, accuracy of the estimated initial conditions for the particular time period including by determining whether the estimated initial conditions for the particular time period are within a threshold value of simulation output values from simulation of an immediately preceding time period.

8. The method of claim 7, where executing the simulation comprises:
responsive to determining that the estimated initial conditions for the particular time period are not within the threshold value of the simulation output values from simulation of the immediately preceding time period:
adjusting the estimated initial conditions for the particular time-period based on the simulation output values to obtain adjusted initial conditions; and
re-simulating behaviors of the electric power system for at least a portion of the particular time-period by applying the adjusted initial conditions.

9. The method of claim 8, where verifying accuracy of the estimated initial conditions comprises:
responsive to determining that the estimated initial conditions for the particular time period are not within the threshold value of the simulation output values from simulation of the time period immediately preceding the particular time period, determining that simulation output values associated with the particular time period converge with simulation output values associated with the immediately preceding time period during a period of overlap between the particular time period and the immediately preceding time period; and
where re-simulating behaviors of the electric power system for at least a portion of the particular time-period by applying the adjusted initial conditions comprises re-simulating only a period of time during which the simulation output values associated with the particular time period did not converge with the simulation output values associated with the immediately preceding time period.

10. The method of claim 1, where each time-period, except for a last one of the time periods, overlaps with a portion of an immediately subsequent time-period.

11. The method of claim 2, where the mutation data comprises one or more of: an addition of a solar power source to the model at a respective time-period, a change to an electric system component at a respective time-period, and an expansion of the electric power system at a respective time-period.

12. A system comprising:
a central computing system in communication with a plurality of processing cores; and one or more data stores coupled to the central computing system and the processing cores, the one or more data stores having instructions stored thereon which, when executed by the central computing system and the processing cores, causes the central computing system and the processing cores to perform operations comprising:
obtaining a model of an electrical power system;
executing a simulation of the model including by separately simulating, in parallel on different ones of the processing cores, behaviors of the electric power system during each of a consecutive series of time periods to provide individual simulation results for each time period, where the consecutive series of time periods together represent a simulation time frame over which the behaviors of the electric power system are simulated;
combining the individual simulation results into a simulation output for the simulation time frame; and
providing, for display, the simulation output.

13. The system of claim 12, the operations comprising:
receiving user input defining simulation parameters that comprise one or more of:
a length of the simulation time frame,
a length of the time periods,
a number of the time periods,
a load curve data representing a baseline load curve of the electrical power system over a canonical time-period, and
mutation data representing one or more alterations to the model and the baseline load curve to be applied during different time periods of the simulation.

14. The system of claim 12, where executing the simulation comprises:
assigning a respective time-period to each of a plurality of processors, where each processor is configured to separately execute simulation of behaviors of the electric power system during the respective time-period.

15. The system of claim 14, where executing the simulation comprises:
providing, to each processor, the model of the electric power system, load curve data representing a baseline load curve of the electrical power system, and mutation data representing one or more alterations, relevant to the respective time period, to at least one of the model or the load curve data.

16. The system of claim 14, where executing the simulation comprises:
generating, for one or more time periods, a time-period specific load curve data representing a baseline load curve of the electrical power system that is adjusted to incorporate mutation data indicating one or more changes to the load curve relevant for the respective time-period; and
providing, to each processor, time-period specific load curve data associated with the respective time-period assigned to the processor.

17. The system of claim 14, where executing the simulation comprises:
generating, for one or more time periods, a time-period specific model representing the model of the electrical power system that is adjusted to incorporate mutation data indicating one or more changes to the electric power system relevant for the respective time-period; and
providing, to each processor, the time-period specific model of the electric power system associated with the respective time-period assigned to the processor.

18. The system of claim 14, where executing the simulation comprises:
applying, for each time period subsequent to a first time period, estimated initial conditions of the electric power system at a start time of the respective time-period;
verifying, for at least one particular time period subsequent to a first time period, accuracy of the estimated initial conditions for the particular time period including by determining whether the estimated initial conditions for the particular time period are within a threshold value of simulation output values from simulation of an immediately preceding time-period; and
responsive to determining that the estimated initial conditions for the particular time-period are not within the threshold value of the simulation output values from simulation of the immediately preceding time-period:
adjusting the estimated initial conditions for the particular time-period based on the simulation output values to obtain adjusted initial conditions; and
re-simulating behaviors of the electric power system for at least a portion of the particular time-period by applying the adjusted initial conditions.

19. The system of claim 18, where verifying accuracy of the estimated initial conditions comprises:
responsive to determining that the estimated initial conditions for the particular time period are not within the threshold value of the simulation output values from simulation of the time period immediately preceding the particular time period, determining that simulation output values associated with the particular time period converge with simulation output values associated with the immediately preceding time period during a period of overlap between the particular time period and the immediately preceding time period; and
where re-simulating behaviors of the electric power system for at least a portion of the particular time-period by applying the adjusted initial conditions comprises re-simulating only a period of time during which the simulation output values associated with the particular time period did not converge with the simulation output values associated with the immediately preceding time period.

20. An electrical power grid simulation method comprising:
obtaining a model of an electrical power system;
executing a first simulation of the model for a first time period to obtain first simulation results representing behaviors of the electric power system during the first time-period;
in parallel with the first simulation, executing a second simulation of the model for a second time period to obtain second simulation results representing behaviors of the electric power system during the second time period, the second time period being immediately consecutive to the first time period within a consecutive series of time periods that together represent a simulation time frame during which behaviors of the electric power system are simulated;
combining the first simulation results and the second simulation results into a simulation output for the simulation time frame; and
providing, for display, the simulation output.
